(19) United States
(12) Patent Application Publication
(10) Pub. No.: US 2024/0149346 A1
(43) Pub. Date: May 9, 2024

(54) THREE-DIMENSIONAL PRINTING WITH REACTION INHIBITION ADDITIVES

(71) Applicant: Hewlett-Packard Development Company, L.P., Spring, TX (US)

(72) Inventors: Thomas Craig ANTHONY, Palo Alto, CA (US); Elizabeth GALATI, Palo Alto, CA (US); Kyle WYCOFF, Palo Alto, CA (US); John Samuel Dilip JANGAM, Palo Alto, CA (US)

(21) Appl. No.: 18/282,168

(22) PCT Filed: Mar. 26, 2021
(86) PCT No.: PCT/US2021/024477

§ 371 Date: Sep. 14, 2023

(51) Int. Cl. B22F 10/14; B33Y 10/00; B33Y 30/00; B33Y 40/20; B33Y 70/10

(52) U.S. Cl. CPC B22F 10/14; B33Y 70/10; B22F 2301/10; B33Y 10/00; B33Y 30/00; B33Y 40/20

(57) ABSTRACT

The present disclosure describes three-dimensional printing kits, three-dimensional printing systems, and methods of making three-dimensional printed objects. In one example, a three-dimensional printing kit can include a build material and a binding agent. The build material can include particles of copper or a copper alloy. The binding agent can include water, copper (II) nitrate or a hydrate thereof, and a reaction inhibition additive. The additive can be a copper oxide etchant, a water-soluble phosphate-containing compound, or a combination thereof.

### BACKGROUND

Three-dimensional (3D) printing is an additive manufacturing process that can be used to make three-dimensional solid parts from a digital model.

Three-dimensional printing is often used in rapid product prototyping, mold generation, mold master generation, and short run manufacturing. Some three-dimensional printing techniques involve the application of successive layers of material. This is unlike other machining processes, which often rely upon the removal of material to create the final part. Some three-dimensional printing methods use chemical binders or adhesives to bind build materials together. Other three-dimensional printing methods involve partial sintering, melting, etc. of the build material. For some materials, partial melting may be accomplished using heat-assisted extrusion, and for some other materials curing or fusing may be accomplished using, for example, ultra-violet light or infrared light.

### BRIEF DESCRIPTION OF THE DRAWINGS

FIG. 1 is a schematic illustration of an example three-dimensional printing kit in accordance with the present disclosure;

FIG. 2 is a schematic illustration of another example three-dimensional printing kit in accordance with the present disclosure;

FIG. 3 is a schematic illustration of an example three-dimensional printing system in accordance with the present disclosure;

FIG. 4 is a schematic illustration of another example three-dimensional printing system in accordance with the present disclosure; and

FIG. 5 is a flowchart illustrating an example method of making a three-dimensional printed object.

### DETAILED DESCRIPTION

The present disclosure describes three-dimensional printing kits, three-dimensional printing systems, and methods of making three-dimensional printed objects. In one example, a three-dimensional printing kit includes a build material and a binding agent. The build material includes particles of copper or a copper alloy. The binding agent includes water, copper (II) nitrate or a hydrate thereof, and a reaction inhibition additive. The additive is a copper oxide etchant, a water-soluble phosphate-containing compound, or a combination thereof. In some examples, the reaction inhibition additive can include a copper oxide etchant selected from the group consisting of acetic acid, phosphoric acid, formic acid, propionic acid, phosphonoacetic acid, oxalic acid, sulfuric acid, nitric acid, or a combination thereof. In other examples, the reaction inhibition additive can include a water-soluble phosphate-containing compound selected from ammonium dihydrogen phosphate, ammonium hydrogen phosphate, ammonium phosphate, phosphoric acid, sodium phosphate, sodium hydrogen phosphate, potassium phosphate, potassium hydrogen phosphate, potassium dihydrogen phosphate, lithium dihydrogen phosphate, lithium hydrogen phosphate, cesium phosphate, or a combination thereof. In certain examples, the reaction inhibition additive can be the copper oxide etchant, and the three-dimensional printing kit can also include a second fluid agent that includes water and a water-soluble phosphate-containing compound. In some examples, the reaction inhibition additive can be present in an amount from about 0.01 wt % to about 5.0 wt % with respect to the total weight of the binding agent. In certain examples, the binding agent can include copper (II) nitrate trihydrate in an amount from about 20 wt % to about 70 wt % with respect to the total weight of the binding agent. In further examples, the binding agent can also include a surfactant in an amount from about 0.025 wt % to about 2 wt % with respect to the total weight of the binding agent. In some other examples, the binding agent can be substantially free of organic humectant or can include an organic humectant in an amount from about 0.1 wt % to about 10 wt %.

The present disclosure also describes three-dimensional printing systems. In one example, a three-dimensional printing system includes a powder bed, a binding agent applicator, and a curing heater. The powder bed includes a build material that includes particles of copper or a copper alloy. The binding agent applicator is fluidly coupled or coupleable to a binding agent, and directable to iteratively apply the binding agent to layers of the build material. The binding agent includes water, copper (II) nitrate or a hydrate thereof, and a reaction inhibition additive, wherein the additive is a copper oxide etchant, a water-soluble phosphate-containing compound, or a combination thereof. The curing heater is positioned to heat the powder bed to a curing temperature. In some examples, the reaction inhibition additive can be acetic acid, phosphoric acid, formic acid, propionic acid, phosphonoacetic acid, oxalic acid, sulfuric acid, nitric acid, ammonium dihydrogen phosphate, ammonium hydrogen phosphate, ammonium phosphate, sodium phosphate, sodium hydrogen phosphate, potassium phosphate, potassium hydrogen phosphate, potassium dihydrogen phosphate, lithium dihydrogen phosphate, lithium hydrogen phosphate, cesium phosphate, or a combination thereof. In further examples, the reaction inhibition additive can be present in an amount from about 0.01 wt % to about 5.0 wt % with respect to the total weight of the binding agent, and the binding agent can include copper (II) nitrate trihydrate in an amount from about 20 wt % to about 70 wt % with respect to the total weight of the binding agent.

The present disclosure also describes methods of making three-dimensional printed objects. In one example, a method of making a three-dimensional printed object includes selectively applying a binding agent onto a build material including particles of copper or a copper alloy. The binding agent includes water, copper (II) nitrate or a hydrate thereof, and a reaction inhibition additive. The additive is a copper oxide etchant, a water-soluble phosphate-containing compound, or a combination thereof. The build material and the selectively applied binding agent are heated to bind a layer of the three-dimensional printed object. In some examples, the reaction inhibition additive can be acetic acid, phosphoric acid, formic acid, propionic acid, phosphonoacetic acid, oxalic acid, sulfuric acid, nitric acid, ammonium dihydrogen phosphate, ammonium hydrogen phosphate, ammonium phosphate, sodium phosphate, sodium hydrogen phosphate, potassium phosphate, potassium hydrogen phosphate, potassium dihydrogen phosphate, lithium dihydrogen phosphate, lithium hydrogen phosphate, cesium phosphate, or a combination thereof. The reaction inhibition additive can be present in an amount from about 0.01 wt % to about 5.0 wt % with respect to the total weight of the binding agent. The binding agent can include copper (II) nitrate trihydrate in an amount from about 20 wt % to about 70 wt % with respect to the total weight of the binding agent. In other examples, the method can also include sintering bound layers of the three-dimensional printed object to form a sintered three-dimensional printed object. In still other examples, the method can also include adding multiple additional layers of the build material and selectively applying the binding agent onto the multiple additional layers of the build material. Heating the build material and selectively applied binding agent can include heating the build material and the multiple additional layers of build material simultaneously to bind an entire three-dimensional printed object.

It is noted that when discussing the shaping compositions, the three-dimensional printing kits, and/or the methods herein, these discussions can be considered applicable to one another whether or not they are explicitly discussed in the context of that example. Thus, for example, when discussing high melting point metal particles of the shaping composition, such disclosure is also relevant to and directly supported in the context of the three-dimensional printing kits and methods, and vice versa, regardless of any scope of description differences.

It is also understood that terms used herein will take on their ordinary meaning in the relevant technical field unless specified otherwise. In some instances, there are terms defined more specifically throughout the specification or included at the end of the present specification, and thus, these terms can have a meaning as described herein.

Three-Dimensional Printing Kits

The three-dimensional printing kits, systems, and methods described herein can be used to make copper or copper alloy three-dimensional printed objects. A certain three-dimensional printing, or additive manufacturing, process can be performed using the materials described herein. In an example, a binding agent can be applied to layers of metal particles that are made of copper or a copper alloy. Successive layers of the metal particles can be added, and binding agent can be applied on the layers to bind the particles together to form layers of a three-dimensional printed green body. The green body can later be fused, such as by sintering, to form a metal object.

The binding agents used in the three-dimensional printing process can include an aqueous solution of copper (II) nitrate. The binding agent can be applied to certain areas of the layers of metal particles. The metal particles and the applied binding agent can then be heated to an elevated temperature at which the copper (II) nitrate can decompose (or partially decompose) to form copper hydroxynitrate (Cu₂(OH)₃NO₃). The copper hydroxynitrate can bind the metal particles together in the green body. When the green body is subsequently fused at a high temperature, the hydrogen, oxygen, and nitrogen in the copper hydroxynitrate can be driven off as gases, and the copper can remain as a part of the fused metal object.

In some cases, chemical reactions can occur between the metal particles and the binding agent when the binding agent is applied to the metal particles. For example, some binding agent formulations that include water and copper (II) nitrate can cause a reaction with copper or copper alloy particles. The reaction can produce gases such as nitric oxide (NO) and nitrogen dioxide (NO₂). The reaction may also oxidize the copper or copper alloy, forming copper (I) oxide (Cu₂O) and/or copper (II) oxide (CuO). If enough gas is released by this reaction, the gas can reduce the density of the three-dimensional printed green body. For example, the gas can become trapped and form bubbles between particles in the green body. The gas can also cause dimensional instability, such as bulging in the surface of the green body. These defects can persist through the sintering process. Thus, the gas released by the reaction can affect the appearance and density of the final sintered metal object. Furthermore, voids created by the gas can negatively affect properties of the final sintered metal object, such as thermal conductivity, electrical conductivity, strength, and others.

The binding agents described herein can include an additive that inhibits the reaction described above. In various examples, the reaction inhibition additive can be a copper oxide etchant, a water-soluble phosphate containing compound, or a combination of both. Binding agents that include the reaction inhibition additive can reduce gas evolution when applied to the metal particles, compared to binding agents that do not include the reaction inhibition additive. Thus, three-dimensional printed green bodies made using the binding agents described herein can have higher density compared to three-dimensional green bodies made using other binding agents. The sintered metal objects that are made by sintering the green bodies can also have better properties compared to sintered metal objects made using other binding agents. In some cases, the reaction inhibition additive can also remove oxidation that is already present on the metal particles. This can also help the metal particles sinter together with a higher density and increased properties such as thermal conductivity and electrical conductivity.

In certain examples, the binding agents described herein can be particularly useful with metal powder build materials that do not already include reaction inhibition additives. For example, some copper powders are available that include a small phosphorus content (such as less than 1 wt %). The phosphorus content in such copper powder can have a similar effect of inhibiting the reaction with the binding agent. However, different copper powder formulations may be made up of pure copper or copper alloys without any phosphorus or other reaction inhibition additives. The binding agents described herein can be used to form three-dimensional printed green body objects from such copper powders without the negative effects of gas evolution from the reactions described above.

Additionally, the amount of the reaction inhibition additive in the binding agent can be adjusted to minimize the amount that is present in the final three-dimensional printed metal object. The amount of binding agent that is applied during the three-dimensional printing process can also be adjusted to control the amount of the reaction inhibition additive that is present in the object. In some examples, the presence of phosphorus in a copper object can cause a significant reduction of the thermal conductivity and electrical conductivity of the copper. However, a very small amount of a phosphate reaction inhibition additive can be applied as a part of the binding agent and this very small amount can be sufficient to reduce or prevent the negative effects of gas evolution described above. This very small amount of phosphate reaction inhibition additive can also be small enough that the influence of the additive on the thermal or electrical conductivity of the copper object can be negligible. Additionally, some phosphorus can be removed during the high temperature debinding and sintering processes. Thus, using a binding agent that includes a reaction inhibition additive can allow for more control over the amount of the reaction inhibition additive that is present in the build material. In certain examples, the binding agent can be formulated and applied such that the amount of phosphorus added to the powder build material is less than about 0.1 wt %, or less than about 0.01 wt %, or less than about 0.005 wt %, with respect to the total weight of the build material. In further examples, the concentration of a water-soluble phosphate-containing compound in the binding agent can be from about 0.01 wt % to about 5 wt %, or from about 0.01 wt % to about 2.5 wt %, or from about 0.025 wt % to about 1 wt %, or from about 0.025 wt % to about 0.5 wt %.

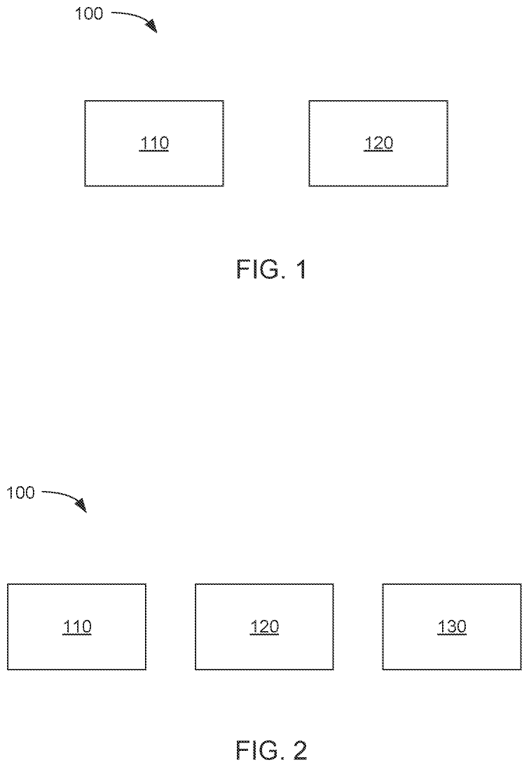

FIG. 1 shows a schematic view of one example three-dimensional printing kit 100 in accordance with the present disclosure. The three-dimensional printing kit includes a build material 110 and a binding agent 120. The build material can include particles of copper or a copper alloy. The binding agent can include water, copper (II) nitrate or a hydrate thereof, and a reaction inhibition additive. The reaction inhibition additive can be a copper oxide etchant, a water-soluble phosphate-containing compound, or a combination thereof.

In some examples, the binding agent can include both a copper oxide etchant and a water-soluble phosphate-containing compound. In other examples, the binding agent can include either a copper oxide etchant or a water-soluble phosphate-containing compound, but not both. Some examples of copper oxide etchants can include acids such as acetic acid, phosphoric acid, formic acid, propionic acid, phosphonoacetic acid, oxalic acid, sulfuric acid, nitric acid, and others. Some example water-soluble phosphate-containing compounds can include ammonium dihydrogen phosphate, ammonium hydrogen phosphate, ammonium phosphate, phosphoric acid, sodium phosphate, sodium hydrogen phosphate, potassium phosphate, potassium hydrogen phosphate, potassium dihydrogen phosphate, lithium dihydrogen phosphate, lithium hydrogen phosphate, cesium phosphate, and others.

In further examples, the three-dimensional printing kit can include a binding agent and a second fluid agent. The binding agent can include either a copper oxide etchant or a water-soluble phosphate-containing compound. Whichever type of reaction inhibition additive is not included in the binding agent can be included in the second fluid agent. Thus, the amounts of the different reaction inhibition additives applied to the build material can be independently controlled. In one example, the binding agent can include a copper oxide etchant and the second fluid agent can include a water-soluble phosphate-containing compound.

FIG. 2 shows another example three-dimensional printing kit 100. This kit includes a build material 110, a binding agent 120, and a second fluid agent 130. In this example, the build material includes particles of copper or a copper alloy. The binding agent includes water, copper (II) nitrate or a hydrate thereof, and a copper oxide etchant. The second fluid agent includes water and a water-soluble phosphate-containing compound. This kit can be used in a three-dimensional printing process in which the binding agent and the second fluid agent can be independently applied selectively to the build material. Thus, the amount of the copper oxide etchant and the phosphate-containing compound can be independently controlled in different portions of the three-dimensional printed green body object. In certain examples, the second fluid agent can also include copper (II) nitrate or a hydrate thereof. In such examples, the second fluid agent can act as a second binding agent.

In some examples, the build material and binding agent can be co-packaged in separate containers. Specifically, a container containing build material and a container containing binding agent can be packaged together. For three-dimensional printing kits that include a second fluid agent, a container containing the second fluid agent can also be included. In other examples, the build material, binding agent, and second fluid agent, if present, can be packaged separately. However, these materials can be combined at the time of three-dimensional printing by loading the materials in a three-dimensional printing system.

More specific examples of build materials, binding agents, other fluid agents, and ingredients that can be included therein are described in more detail below.

Three-Dimensional Printing Systems

Three-dimensional printing systems can be used with the build materials and binding agents described herein to make three-dimensional printed objects. In some examples, a three-dimensional printing system can include a powder bed for holding layers of the build material. A binding agent applicator can be positioned to selectively apply a binding agent onto the layers of build material. For example, the binding agent applicator can be controllable to apply the binding agent at specific, x/y coordinates of the layer of build material. Additionally, the three-dimensional printing systems can include a curing heater. As used herein, “curing” can refer to a process of heating the build material and binding agent so that solvents in the binding agent evaporate and the copper (II) nitrate in the binding agent is dehydrated or partially dehydrated. In a specific example, the binding agent can include copper (II) nitrate trihydrate, and curing can include heating the binding agent until the copper (II) nitrate trihydrate decomposes to form copper hydroxynitrate.

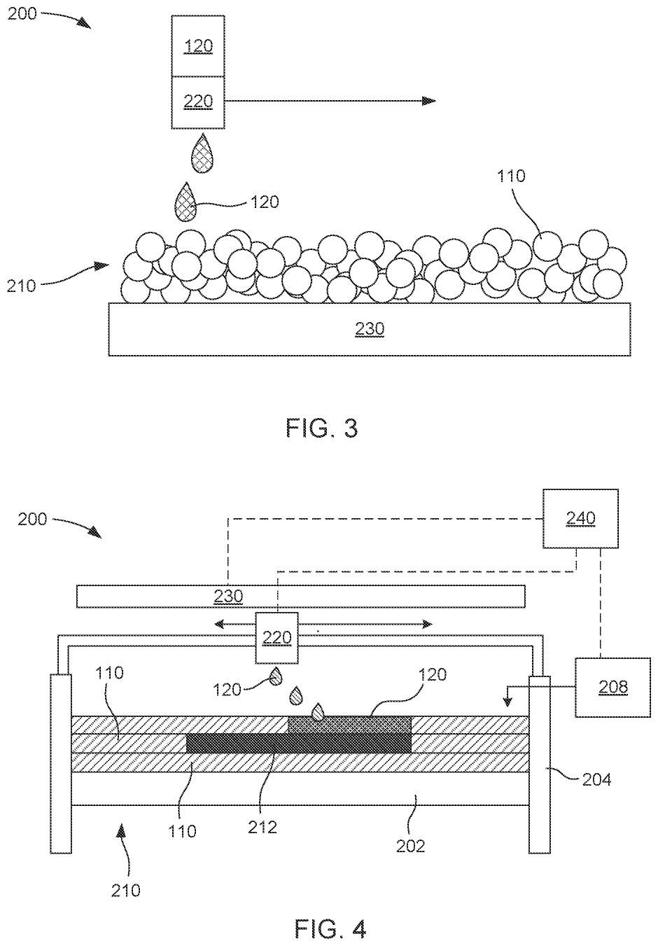

FIG. 3 is a schematic diagram of an example three-dimensional printing system 200 in accordance with the present disclosure. The system includes a powder bed 210 that includes a build material 110. The build material includes particles of copper or a copper alloy. The system also includes a binding agent applicator 220. The binding agent applicator is fluidly coupled to a binding agent 120 and the binding agent applicator is directable to iteratively apply the binding agent to layers of the build material. The binding agent can include water, copper (II) nitrate or a hydrate thereof, and a reaction inhibition additive. As explained above, the reaction inhibition additive can be a copper oxide etchant, a water-soluble phosphate-containing compound, or a combination thereof. The system also includes a curing heater 230 positioned to heat the powder bed to a curing temperature.

It is noted that three-dimensional printing systems can include a variety of additional components besides the components shown in FIG. 3. Examples of additional components include a build material distributor, a supply of additional build material, a fluid applicator for applying a second fluid agent, a hardware controller to send instructions to other components in the system, a non-transitory computer readable medium having stored computer executable instructions to cause the hardware controller to send instructions to other components of the system to perform a three-dimensional printing method, a sintering oven, and others.

FIG. 4 shows another example three-dimensional printing system 200 that includes some of these additional components. In this example, the system includes a powder bed 210 having a build material platform 202 and side walls 204. A build material applicator 208 is configured to deposit individual layers of build material 110 on the build material platform, or on top of a previous layer of build material. The system also includes a binding agent applicator 220 that is positioned above the powder bed. The binding agent applicator is moveable so that the binding agent applicator can apply a binding agent 120 to the layers of build material. A curing heater 230 is positioned to heat the powder bed. In this example, the curing heater can heat the individual layers of build material after the binding agent is applied to form individual green body layers 212 that are made up of bound metal particles. A hardware controller 240 communicates with the curing heater, the binding agent applicator, and the build material applicator to send instructions to these components to perform a three-dimensional printing method.

In some examples, the binding agent applicator can be moveable along two axes, such as an x-axis and a y-axis, to allow the binding agent to be selectively applied to any desired location on the layers of build material. In other examples, the binding agent applicator can be large enough to extend across one entire dimension of the powder bed, and the binding agent applicator can be moveable along one axis. For example, the binding agent applicator can include a plurality of nozzles along the length of the binding agent applicator, and binding agent can be selectively jetted from the individual nozzles. The binding agent applicator can then scan across the powder bed and the binding agent can be selectively jetted from the nozzles to allow the binding agent to be applied to any desired location on the powder bed. In other examples, the powder bed itself can be moveable. For example, the powder can be moveable and the binding agent applicator can be stationary. In either example, the binding agent applicator and the powder bed can be configured so that binding agent can be selectively applied to specific portions of the powder bed. The binding agent applicator can be configured to print drops of the binding agent at a resolution ranging from about 300 dots per inch (DPI) to about 1200 DPI in some examples. Higher resolutions or lower resolutions can also be used. The volume of individual drops of binding agent can be from about 1 pL to about 400 pL in some examples. The firing frequency of nozzles of the binding agent applicator can be from about 1 kHz to about 100 kHz in certain examples.

In the example of FIG. 4, the curing heater is used to cure individual layers of the build material after the binding agent is applied to the individual layers. In other examples, the curing heater can apply heat to cure multiple layers at one time. For example, the layers can be cured after every five layers have been deposited, or after every ten layers, or after every twenty layers, and so on. Alternatively, the curing heater can be used after all of the layers have been deposited and binding agent has been applied thereon. The entire powder bed can then be heated to a curing temperature to cure the entire green body object at one time.

The build material applicator can deposit a layer of build material onto the build platform, where the layer of build material can be flattened or smoothed on a layer by layer basis, such as by a mechanical roller, a spreading blade, or other flattening technique. A layer of the build material can be deposited and spread out evenly at the top surface. As mentioned above, the build material can include particles of copper or a copper alloy. The layer of build material can have a layer thickness from about 25 μm to about 400 μm, from 75 μm to about 400 μm, from about 100 μm to about 400 μm, from about 150 μm to about 350 μm, or from about 30 μm to about 100 μm, for example. The binding agent can be used to generate the green body object on a layer-by-layer basis, for example. As explained above, the binding agent can be applied to certain portions of the build material layer in the shape of a layer of the green body object. The shape of the layer of the green body object can be based on a three-dimensional computer model, for example. After individual layers have been printed with the binding agent, the build platform can be dropped a distance corresponding to a thickness of the applied layer of build material, e.g., about 50 μm to about 200 μm, so that another layer of the build material can be added thereon and printed with the binding agent, etc. The process can be repeated on a layer by layer basis until a green body object is formed. As mentioned above, a curing heater can be used to cure the green body object, either on a layer-by-layer basis or in a single curing operation after the entire green body object has been formed in the powder bed. The green body object can be stable enough to move to an oven suitable for fusing, e.g., sintering, annealing, or the like.

Methods of Making Three-Dimensional Printed Objects

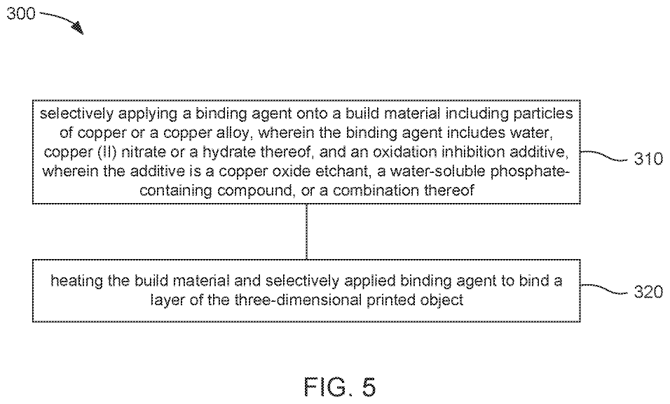

The three-dimensional printing kits and systems described herein can be used to perform methods of making three-dimensional printed objects. FIG. 5 is a flowchart showing one example method 300 of making a three-dimensional printed object. The method includes: selectively applying a binding agent onto a build material including particles of copper or a copper alloy, wherein the binding agent includes water, copper (II) nitrate or a hydrate thereof, and a reaction inhibition additive, wherein the additive is a copper oxide etchant, a water-soluble phosphate-containing compound, or a combination thereof 310; and heating the build material and selectively applied binding agent to bind a layer of the three-dimensional printed object 320.

The amount of copper (II) nitrate that is introduced into the build material by the binding agent can be sufficient to bind the build material particles together. In some examples, the concentration of copper (II) nitrate in the build material, after the binding agent has been applied, can be from about 0.2 wt % to about 20 wt % based on the combined weight of the build material particles and the copper (II) nitrate. In other examples, the concentration of copper (II) nitrate can be from about 0.2 wt % to about 15 wt % or from about 0.2 wt % to about 10 wt %, or from about 0.2 wt % to about 5 wt %, or from about 0.2 wt % to about 1 wt %.

In further examples, the build material having the binding agent applied thereon can be heated to a curing temperature. As explained above, this can dehydrate or partially dehydrate the copper (II) nitrate in the binding agent, forming a compound that can bind the build material particles together. A three-dimensional printed body of build material particles that are held together in this way can be referred to as a “green body” or “green body object.” In some examples, individual layers of build material and binding agent can be heated and cured to form individual layers of the final green body object. In other examples, multiple layers of build material can have the binding agent applied thereon and then the multiple layers can be cured simultaneously. In one example, all of the layers can be formed in the powder bed, without curing, and then at the end of the three-dimensional printing process the entire powder bed can be heated to a curing temperature to cure the entire green body object simultaneously. The green body object can be made up of the build material particles and the binding agent before being fused (such as by sintering or annealing) but which are held together sufficiently to permit the object to be handled and moved to a sintering oven or other device for fusing the green body object.

The heat for curing can be provided by a curing heater that is positioned to heat the build material in the powder bed. In some examples, the curing heater can be positioned above the powder bed. In other examples, the build platform beneath the powder bed can be heated. Heaters can also be positioned on sides of the powder bed. A combination of these heaters can also be used. The temperature at which the build material and the binding agent are cured can be from about 70° C. to about 250° C. in some examples. In further examples, the curing temperature can be from about 70° C. to about 160° C., or from about 70° C. to about 120° C., or from about 100° C. to about 160° C., or from about 140° C. to about 160° C., or from about 140° C. to about 250° C. The curing time can be from about 1 second to about 4 hours. In some examples, curing can be performed on individual layers of build material, and the curing time can be from about 1 second to about 1 minute per layer. In other examples, the curing can be performed for the entire green body object simultaneously, and the curing time can be from about 15 minutes to about 4 hours, or from about 20 minutes to about 3 hours, or from about 30 minutes to about 2 hours, or from about 1 hour to about 2 hours.

In some examples, the green body object can be fully cured in the powder bed of the three-dimensional printing system. In other examples, a first curing stage can be performed in the powder bed, and then a second curing stage can be performed in another location, such as in a curing oven. In certain examples, the second curing stage can expose the green body object to a higher curing temperature than the first curing stage. In one example, the green body object can be cured in a first curing stage within the powder bed at a first curing temperature from about 70° C. to about 160° C., and then additionally cured in a second curing stage at a second curing temperature from about 140° C. to about 250° C.

After curing the three-dimensional printed green body object, the green body object can be fused. The terms “fuse,” “fused,” “fusing,” or the like refers to metal particles of a green body object that have become heat-joined at high temperatures, depending on a variety of variables, e.g., particle size, type of metal, metal purity, weight percent of metal content, etc. Fusing may be in the form of melting, sintering, annealing, etc., of the metal particles, and can include a complete fusing of adjacent particles into a common structure, e.g., melting together, or can include surface fusing where particles are not fully melted to a point of liquefaction, but which allow for individual particles of the build material to become bound to one another, e.g., forming material bridges between particles at or near a point of contact. Fusing can include particles becoming melted together as a unitary solid mass, or can include surfaces of metal build particles becoming softened or melted to join together at particle interfaces. In either case, the metal build particles become joined and the fused metal object can be handled and/or used as a rigid part or object without the fragility of the green body object.

Sintering of metal build particles is one form of metal particle fusing. Annealing is another form of metal particle fusing. A third type of fusing includes melting metal build particles together to form a unitary mass. The terms “sinter,” “sintered,” “sintering,” or the like refers to the consolidation and physical bonding of the metal build particles together (after temporary binding using the binding agent) by solid state diffusion bonding, partial melting of metal build particles, or a combination of solid state diffusion bonding and partial melting. The term “anneal” refers to a heating and cooling sequence that controls the heating process, and the cooling process, e.g., slowing cooling in some instances, to remove internal stresses and/or toughen the fused metal object.

In certain examples, the green body object can be sintered in a sintering oven. Sintering can be performed at various temperatures, depending on the specific type of metal particles present in the build material. In some examples, the sintering temperature can be from about 750° C. to about 1300° C. In further examples, the sintering temperature can be from about 800° C. to about 1300° C., or from about 900° C. to about 1300° C., or from about 1000° C. to about 1300° C., or from about 1100° C. to about 1300° C., or from about 1200° C. to about 1300° C., or from about 800° C. to about 1200° C., or from about 900° C. to about 1200° C., or from about 1000° C. to about 1200° C., or from about 1100° C. to about 1200° C., or from about 800° C. to about 1100° C., or from about 900° C. to about 1100° C., or from about 1000° C. to about 1100° C. Sintering can be performed for a sintering time from about 10 minutes to about 20 hours, or from about 30 minutes to about hours, or from about 1 hour to about 5 hours, in some examples. The sintering can be performed in an atmosphere or vacuum. In some examples, the sintering atmosphere can be an inert gas, a low-reactivity gas, a reducing gas, or a combination thereof. Some gases that can be used in the sintering atmosphere include hydrogen, helium, argon, neon, xenon, krypton, nitrogen, carbon monoxide, and combinations thereof.

Build Materials

The build materials used in the three-dimensional printing kits described herein can include metal particles. As mentioned above, in some examples the build material can include particles of copper or a copper alloy. In certain examples, copper alloys can include brass, copper-zinc alloys, bronze, copper-tin alloys, aluminum bronze, magnesium bronze, silicon bronze, phosphor bronze, copper-nickel alloys, copper-chromium alloys, monel, nickel-copper alloys, copper-gold alloys, copper-silver alloys, and others. Other metals that can be included in the build material include steels, stainless steel, titanium, titanium alloys, aluminum, aluminum alloys, nickel, nickel alloys, cobalt, cobalt alloys, iron, iron alloys, gold, gold alloys, silver, silver alloys, platinum, platinum alloys, and combinations thereof. Specific examples of copper powder include copper powders available from Goodfellow Corporation (USA), and copper powder available from Sandvik AB (Sweden).

As mentioned above, some copper powders may include a small amount of phosphorus to inhibit oxidation. However, in some examples the build material used in the three-dimensional printing kits described herein can be free of phosphorus content or substantially free of phosphorus content. In certain examples, the build material can be a pure copper powder.

In various examples, the build material can include similarly-sized particles or differently-sized particles. In some examples, the build material can have a D50 particle size from about 1 micrometer to about 150 micrometers, or from about 5 micrometers to about 50 micrometers, or from about 10 micrometers to about 30 micrometers. As used herein, particle size can refer to a value of the diameter of spherical particles or in particles that are not spherical can refer to a longest dimension of that particle. The particle size can be presented as a Gaussian distribution or a Gaussian-like distribution (or normal or normal-like distribution). Gaussian-like distributions are distribution curves that can appear Gaussian in their distribution curve shape, but which can be slightly skewed in one direction or the other (toward the smaller end or toward the larger end of the particle size distribution range). That being stated, an example Gaussian-like distribution of the metal build particles can be characterized using “D10,” “D50,” and “D90” particle size distribution values, where D10 refers to the particle size at the 10^{th} percentile, D50 refers to the particle size at the 50^{th} percentile, and D90 refers to the particle size at the 90^{th} percentile. For example, a D50 value of 25 μm means that 50% of the particles (by number) have a particle size greater than 25 μm and 50% of the particles have a particle size less than 25 μm. Particle size distribution values may not be related to Gaussian distribution curves, but in one example of the present disclosure, the metal build particles can have a Gaussian distribution, or more typically a Gaussian-like distribution with offset peaks at about D50. In practice, true Gaussian distributions are not typically present, as some skewing can be present, but still, the Gaussian-like distribution can be considered to be “Gaussian” as used in practice. The shape of the particles of the build material can be spherical, non-spherical, random shapes, or a combination thereof.

Binding Agents

The binding agents used in the three-dimensional printing kits can include water, copper (II) nitrate or a hydrate thereof, and a reaction inhibition additive. As explained above, the reaction inhibition additive can be a copper oxide etchant, a water-soluble phosphate-containing compound, or a combination thereof. In some examples, the copper (II) nitrate or hydrate thereof can be included in an amount from about 20 wt % to about 70 wt %, or from about 30 wt % to about 60 wt %, or from about 35 wt % to about 50 wt %. In certain examples, the copper (II) nitrate can be in the form of anhydrous copper (II) nitrate, copper (II) nitrate monohydrate, copper (II) nitrate sesquihydrate, copper (II) nitrate hemipentahydrate, copper (II) nitrate trihydrate, or copper (II) nitrate hexahydrate. In a particular example, the binding agent can include copper (II) nitrate trihydrate in an amount from about 20 wt % to about 70 wt %.

The reaction inhibition additive can be included in an amount from about 0.01 wt % to about 5.0 wt % with respect to the total weight of the binding agent, in some examples. In further examples, the amount of reaction inhibition additive can be from about 0.05 wt % to about 5 wt %, or from about 0.075 wt % to about 5 wt %, or from about 0.1 wt % to about 5 wt %, or from about 0.25 wt % to about 5 wt %, or from about 0.5 wt % to about 5 wt %. In some examples, the binding agent can include both a copper oxide etchant and a water-soluble phosphate-containing compound. In such examples, the concentration ranges given above can be the combined concentration of both the copper oxide etchant and the phosphate-containing compound. In some examples, the amount of the copper oxide etchant can be greater than the amount of water-soluble phosphate-containing compound included in the binding agent. In certain examples, a weight ratio of the copper oxide etchant to the water-soluble phosphate-containing compound can be from about 2:1 to about 10:1, or from about 2:1 to about 5:1.

Non-limiting examples of copper oxide etchants that can be included in the binding agent can include acids such as acetic acid, phosphoric acid, formic acid, propionic acid, phosphonoacetic acid, oxalic acid, sulfuric acid, nitric acid, and others. Non-limiting examples of water-soluble phosphate-containing compounds can include ammonium dihydrogen phosphate, ammonium hydrogen phosphate, ammonium phosphate, phosphoric acid, sodium phosphate, sodium hydrogen phosphate, potassium phosphate, potassium hydrogen phosphate, potassium dihydrogen phosphate, lithium dihydrogen phosphate, lithium hydrogen phosphate, cesium phosphate, and others. In certain examples, the binding agent can include phosphoric acid, ammonium dihydrogen phosphate, acetic acid, or a combination thereof. In further examples, the binding agent can include phosphoric acid without any other reaction inhibition additives. In other examples, the binding agent can include acetic acid without any additional reaction inhibition additives. In still further examples, the binding agent can include ammonium dihydrogen phosphate without any additional reaction inhibition additives. In other examples, the binding agent can include a combination of acetic acid and ammonium dihydrogen phosphate or a combination of phosphoric acid and ammonium dihydrogen phosphate, without any other reaction inhibition additives. In certain examples, the binding agent can include acetic acid in an amount from about 0.5 wt % to about 2.5 wt %, and/or phosphoric acid in an amount from about 0.025 wt % to about 5 wt %, and/or ammonium dihydrogen phosphate in an amount from about 0.2 wt % to about 5 wt %.

The binding agent can also include a surfactant in some examples. Surfactants can be used to increase the wetting properties and the jettability of the binding agent. Non-limiting examples of surfactants that can be used include: DOWFAX™ 2A1 from Dow Inc. (USA); SURFYNOL® SEF from Air Products and Chemicals, Inc. (USA); nonionic fluorosurfactants such as CAPSTONE® fluorosurfactants from DuPont (USA); ethoxylated low-foam wetting agents such as SURFYNOL®440 or SURFYNOL® CT-111 from Air Products and Chemicals Inc. (USA); an ethoxylated wetting agent and molecular defoamer such as SURFYNOL® 420 from Air Products and Chemicals, Inc. (USA); non-ionic wetting agents and molecular defoamers such as SURFYNOL® 104E from Air Products and Chemicals Inc. (USA); water-soluble, non-ionic surfactants such as TERGITOL™ TMN-6 or TERGITOL™ 15-S-7 from Dow Inc. (USA). A single surfactant or a combination of surfactants can be used. The total amount of surfactant in the binding agent can be from about 0.025 wt % to about 2 wt % in some examples.

A pH-adjusting additive can also be included in the binding agent in some examples. The pH-adjusting additive can be included in a sufficient amount to provide a binding agent having a pH from about 0 to about 3, or from about 1 to about 2, in some examples. Additionally, the pH-adjusting additive can be free of elements that would remain in the metal object after sintering. For example, some pH-adjusting additives such as potassium hydroxide can leave behind undesired elements, such as potassium, in the metal object after sintering. Accordingly, the pH-adjusting additives included in the binding can include elements that can volatilize and/or combust during the sintering process so that no undesired elements are left behind in the sintered metal object. Some examples of pH-adjusting additives that can be used include ammonium acetate and ammonium hydroxide. The amount of pH-adjusting additive can be from about 0.1 wt % to about 5 wt % in some examples.

The binding agent can also include water. In some examples, water can be used as a solvent for the binding agent without any additional co-solvents. Accordingly, in some examples, the binding agent can consist of water, copper (II) nitrate or a hydrate thereof, and a reaction inhibition additive. In further examples, the binding agent can consist of those ingredients plus a surfactant and/or a pH-adjusting additive. The amount of water in the binding agent can be from about 20 wt % to about 79 wt %.

In alternative examples, the binding agent can include water and an organic co-solvent. Organic co-solvents can include 2-pyrrolidone, 1-(2-hydroxyethyl)-2-pyrrolidone, tripropylene glycol mono methyl ether, dipropylene glycol mono methyl ether, dipropylene glycol mono propyl ether, tripropylene glycol mono n-butyl ether, propylene glycol phenyl ether, dipropylene glycol methyl ether acetate, diethylene glycol mono butyl ether, diethylene glycol mono hexyl ether, ethylene glycol phenyl ether, diethylene glycol mono n-butyl ether acetate, ethylene glycol mono n-butyl ether acetate, 2-methyl-1,3-propanediol, or combinations thereof. In some examples, the organic co-solvent can be included in an amount from about 0.1 wt % to about 20 wt %, or from about 0.1 wt % to about 10 wt %, or from about 0.1 wt % to about 2 wt %. However, in some examples, the binding agent can be free of organic humectant or substantially free of organic humectant. Organic humectants can include organic solvents having a boiling point of 120° C. or higher. Some organic humectants can cause flammability or explosion hazards during printing or curing. However, some humectants may be used safely. Therefore, in certain examples, the binding agent can be substantially free of organic humectant or can include an organic humectant in an amount from about 0.1 wt % to about 10 wt %.

The binding agent can include additional additives in some cases, such as anti-microbial agents, anti-kogation agents, and sequestering agents. Example antimicrobial agents may include NUOSEPT™ (Troy Corp., USA), UCARCIDE™ (Dow Chemical Co., USA), ACTICIDE® M20 (Thor, United Kingdom), an aqueous solution of 1,2-benzisothiazolin-3-one such as PROXEL® GXL from Arch Chemicals, Inc. (USA), quaternary ammonium compounds such as BARDAC® 2250 and 2280, BARQUAT® 50-658, and CARBOQUAT®250-T, all from Lonza Ltd. Corp. (Switzerland), an aqueous solution of methylisothiazolone such as KORDEK® MLX from Dow Chemical Co. (USA), or combinations thereof. The biocide or antimicrobial agent may be added in any amount ranging from about 0.05 wt % to about 0.5 wt % with respect to the total weight of the binding agent.

An anti-kogation agent can also be included in the binding agent. Kogation refers to deposits formed on a heating element of a thermal inkjet printhead. Anti-kogation agents can be included to assist in preventing the buildup of kogation. Examples of suitable anti-kogation agents include oleth-3-phosphate such as CRODAFOS™ 03A or CRODAFOS™ N-3 acid from Croda (United Kingdom), or a combination of oleth-3-phosphate and a low molecular weight (e.g., <5,000) polyacrylic acid polymer such as CARBOSPERSE™ K-7028 Polyacrylate from Lubrizol (USA). Whether a single anti-kogation agent is used or a combination of anti-kogation agents is used, the total amount of anti-kogation agent in the binding agent can range from about 0.2 wt % to about 0.6 wt % based on the total weight of the binding agent, in some examples.

Sequestering agents, such as EDTA (ethylene diamine tetra acetic acid), can be included to eliminate the deleterious effects of heavy metal impurities. From 0.01 wt % to 2 wt % of such components can be included in some examples. Viscosity modifiers and buffers may also be present, as well as other additives to modify properties of the binding agent. Such additives can be present in amounts ranging from about 0.01 wt % to about 20 wt % in various examples.

### Definitions

It is noted that, as used in this specification and the appended claims, the singular forms “a,” “an,” and “the” include plural referents unless the content clearly dictates otherwise.

The term “about” as used herein, when referring to a numerical value or range, allows for a degree of variability in the value or range, for example, within 10%, or, in one aspect within 5%, of a stated value or of a stated limit of a range. The term “about” when modifying a numerical range is also understood to include as one numerical subrange a range defined by the exact numerical value indicated, e.g., the range of about 1 wt % to about 5 wt % includes 1 wt % to 5 wt % as an explicitly supported sub-range.

As used herein, “kit” can be synonymous with and understood to include a plurality of compositions including multiple components where the different compositions can be separately contained in the same or multiple containers prior to and during use, e.g., printing a three-dimensional object, but these components can be combined together during a printing process. The containers can be any type of a vessel, box, or receptacle made of any material.

As used herein, a plurality of items, structural elements, compositional elements, and/or materials may be presented in a common list for convenience. However, these lists should be construed as though the individual member of the list is identified as a separate and unique member. Thus, no individual member of such list should be construed as a de facto equivalent of any other member of the same list based on their presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, as well as to include all the individual numerical values or sub-ranges encompassed within that range as the individual numerical value and/or sub-range is explicitly recited. For example, a weight ratio range of about 1 wt % to about 20 wt % should be interpreted to include the explicitly recited limits of 1 wt % and 20 wt % and to include individual weights such as about 2 wt %, about 11 wt %, about 14 wt %, and sub-ranges such as about 10 wt % to about 20 wt %, about 5 wt % to about 15 wt %, etc.

### EXAMPLES

The following illustrates examples of the present disclosure. However, it is to be understood that the following is illustrative of the application of the principles of the present disclosure. Numerous modifications and alternative compositions, methods, and systems may be devised without departing from the spirit and scope of the present disclosure. The appended claims are intended to cover such modifications and arrangements.

### Example 1—Binding Agent Formulations

A series of sample binding agent formulations were prepared. Samples no. 1 through no. 42 included a reaction inhibition additive, which included a copper oxide etchant or a phosphate-containing compound or a combination of both. Comparative samples no. 1 and no. 2 did not include a reaction inhibition additive, but included other additives. The samples all included copper (II) nitrate trihydrate as a binder. Table 1 shows the additives present in the sample formulations, and the concentration of the respective additives, the concentration of the copper (II) nitrate trihydrate, and the pH of the sample formulations.

TABLE 1
Binding Agent Formulations

| | | | Copper | |
|---|---|---|---|---|
| | | | (II) Nitrate | |
| | | Additive | Trihydrate | |
| Sample | Additive | wt % | wt % | pH |
| 1 | H₃PO₄ | 10 | 54 | N/A |
| 2 | H₃PO₄/AdHP | 0.8/5.0 | 42 | N/A |
| 3 | H₃PO₄/AdHP | 0.1/0.5 | 40 | 1.24 |
| 4 | Acetic acid | 2.5 | 40 | 0.74 |
| 5 | Acetic acid | 2.5 | 40 | 0.74 |
| 6 | Acetic acid | 0.5 | 40 | 1.1 |
| 7 | Formic acid | 0.5 | 40 | 0.67 |
| 8 | Formic acid | 0.5 | 40 | 0.67 |
| 9 | Acetic acid/AdHP | 2.5/1.0 | 40 | 0.85 |
| 10 | Acetic acid/AdHP | 1.0/0.2 | 40 | 0.96 |
| 11 | Acetic acid/ammonium | 2.5/5.0 | 40 | 2.26 |
| | acetate | | | |
| 12 | Acetic | 2.5/1/5/0.5 | 40 | 0.9 |
| | acid/AdHP/2P/DF2A1 | | | |
| 13 | AdHP | 1 | 40 | N/A |
| 14 | Ascorbic acid | 10 | 40 | −0.1 |
| 15 | Citric acid | 10 | 40 | −0.1 |
| 16 | H₃PO₄ | 0.025 | 40 | 1.24 |
| 17 | H₃PO₄ | 0.05 | 40 | 1.11 |
| 18 | H₃PO₄ | 0.1 | 40 | 1.16 |
| 19 | H₃PO₄ | 0.175 | 40 | 0.93 |
| 20 | H₃PO₄ | 0.25 | 40 | 0.8 |
| 21 | H₃PO₄ | 0.5 | 40 | 0.6 |
| 22 | H₃PO₄ | 2 | 40 | 0.3 |
| 23 | H₃PO₄ | 4 | 40 | 0 |
| 24 | H₃PO₄ | 8 | 40 | −0.1 |
| 25 | Acetic acid | 2.5 | 40 | 0.74 |
| 26 | Acetic acid | 0.5 | 40 | 1.1 |
| 27 | Acetic acid | 2.5 | 40 | 0.74 |
| 28 | Acetic acid/AdHP | 2.5/1.0 | 40 | 1.1 |
| 29 | Acetic acid/KOH | 2.5/* | 40 | 1.35 |
| 30 | Acetic | 2.5/1.0/0.1 | 40 | 0.68 |
| | acid/AdHP/TMN-6 | | | |
| 31 | Acetic | 2.5/1.0/0.1/7.5 | 40 | 0.8 |
| | acid/AdHP/TMN-6/HE2P | | | |
| 32 | Acetic acid/AdHP | 1.0/0.2 | 40 | 1.1 |
| 33 | Acetic acid/AdHP | 0.5/0.1 | 40 | N/A |
| 34 | Acetic acid | 1 | 40 | N/A |
| 35 | AdHP | 0.2 | 40 | N/A |
| 36 | Acetic acid/AdHP | 0.5/0.15 | 40 | N/A |
| 37 | Acetic acid/AdHP | 0.25/.015 | 40 | N/A |
| 38 | Acetic acid/AdHP | 0.5/0.075 | 40 | N/A |
| 39 | Acetic | 1/0.075/0.25 | 40 | N/A |
| | acid/AdHP/DF2A1 | | | |
| 40 | Acetic | 0.5/0.075/0.25 | 40 | N/A |
| | acid/H₃PO₄/DF2A1 | | | |
| 41 | Acetic | 0.5/0.1/0.5 | 40 | N/A |
| | acid/H₃PO₄/DF2A1 | | | |
| 42 | Acetic | 0.5/0.1/0.5 | 40 | N/A |
| | acid/AdBP/DF2A1 | | | |
| Comp. | 2P/DF2A1/FS-35 | 7.5/0.5 | 40 | N/A |
| 1 | | | | |
| Comp. | Propylene | 7.5/0.5 | 40 | N/A |
| 2 | glycol/DF2A1/FS-35 | | | |

*The amount of KOH added was sufficient to provide a pH of 1.35.

In Table 1, AdHP refers to ammonium dihydrogen phosphate; AdBP refers to ammonium phosphate dibasic; 2P refers to 2-pyrrolidone; DF2A1 refers to DOWFAX™ 2A1 surfactant available from Dow Inc. (USA); KOH refers to potassium hydroxide; TMN-6 refers to TERGITOL™ TMN-6 surfactant available from Dow Inc. (USA); HE2P refers to 1-(2-hydroxyethyl)-2-pyrrolidone; and FS-35 refers to CAPSTONE™ FS-35 surfactant available from The Chemours Company (USA). Values of “N/A” were not measured.

### Example 2—Preparation of Molded Copper Bars

The binding agents in Table 1 were tested by forming molded copper bars from a mixture of the binding agents and copper powder. The copper powder included copper particles having a particle size of 22 micrometers or less, and did not include any phosphorus content in the powder. One part by weight of binding agent was mixed with ten parts by weight of the copper powder and bars were formed from the mixture in a mold. The bars were then cured by heating on a hotplate in three stages of 70° C. for 1 hour, 100° C. for 1 hour, and 150° C. for 1 hour to form green bodies. The green body strength was measured using a 3-point break strength test. In this test, the bar was supported on knife edges on opposite ends of the bar and a ramped force was applied to the opposite side until the bar broke. The tensile stress on the outer edge of the bar at the break point was designated as break strength. The density of the green bodies was also measured, as compared to a solid copper bar. The amount of phosphorus added to the copper powder by the binding agent was also calculated. As explained above, lower phosphorus concentrations can be useful in some cases to provide higher thermal conductivity and electrical conductivity. Table 2 shows the amount of phosphorus added by the binding agents, the average strength of the molded bars, the strength range for any binding agents that were used to make multiple molded bars, and the average density of the molded bars.

TABLE 2

| | Phosphorus wt % | Average | Strength | Average |
|---|---|---|---|---|
| Sample | Added to Powder | Strength (MPa) | Range (MPa) | Density (%) |
| 1 | 2.87E−01 | 10.6 | 6.6-12.9 | 56.3 |
| 2 | 1.45E−01 | 11.2 | 10.5-12.1 | 52.2 |
| 3 | 1.50E−02 | 5.8 | 5.5-6.4 | 53.3 |
| 4 | 0 | 8.6 | 8.4-8.7 | 48.0 |
| 5 | 0 | 11.2 | 10.2-12.5 | 54.3 |
| 6 | 0 | 4.3 | 3.6-5.1 | 46.7 |
| 7 | 0 | 2.1 | 1.8-2.4 | 48.0 |
| 8 | 0 | 1.8 | N/A | 49.1 |
| 9 | 2.40E−02 | 10.4 | 7.3-12.1 | 60.3 |
| 10 | 4.80E−03 | 11.0 | 6.8-13.4 | 57.8 |
| 11 | 0 | 6.7 | 3.4-9.5 | 53.7 |
| 12 | 4.80E−03 | 6.5 | 5.3-8.1 | 53.1 |
| 13 | 2.40E−02 | 6.1 | 5.4-7.7 | 57.3 |
| 14 | 0 | 2.3 | 2.2-2.3 | 48.1 |
| 15 | 0 | 3.3 | 2.6-4.0 | 47.6 |
| 16 | 7.18E−04 | 1.3 | N/A | 48.1 |
| 17 | 1.44E−03 | 5.2 | N/A | 51.9 |
| 18 | 2.87E−03 | 6.8 | N/A | 53.0 |
| 19 | 5.02E−03 | 9.8 | N/A | 59.4 |
| 20 | 7.18E−03 | 10.9 | N/A | 58.8 |
| 21 | 1.44E−02 | 10.8 | N/A | 60.1 |
| 22 | 5.74E−02 | 5.3 | N/A | 58.5 |
| 23 | 1.15E−01 | 4.9 | N/A | 59.3 |
| 24 | 2.30E−01 | 3.6 | N/A | 57.7 |
| 25 | 0 | 8.6 | N/A | 48.0 |
| 26 | 0 | 4.3 | N/A | 46.7 |
| 27 | 0 | 11.2 | N/A | 54.3 |
| 28 | 2.40E−02 | 11.8 | N/A | 60.3 |
| 29 | 0 | 7.0 | N/A | 50.3 |
| 30 | 2.40E−02 | 8.2 | N/A | 57.2 |
| 31 | 2.40E−02 | 6.9 | N/A | 57.5 |
| 32 | 4.80E−03 | 11.8 | N/A | 57.8 |
| 33 | 2.45E−03 | 13.4 | 12.7-14.2 | 53.4 |
| 34 | 0 | 8.5 | 8.5-8.6 | 49 |
| 35 | 4.90E−03 | 7.9 | 2.9-10.32 | 55.8 |
| 36 | 3.67E−03 | 11.5 | 10.9-12.0 | 54.8 |
| 37 | 3.67E−03 | 9.4 | 8.0-9.7 | 55.02 |
| 38 | 1.84E−03 | N/A | N/A | N/A |
| 39 | 1.84E−03 | N/A | N/A | N/A |
| 40 | 5.03E−03 | N/A | N/A | N/A |
| 41 | 2.87E−03 | N/A | N/A | N/A |
| 42 | 2.13E−03 | N/A | N/A | N/A |
| Comp. 1 | 0 | 0.44 | N/A | 21.6 |
| Comp. 2 | 0 | 3.13 | 2.0-5.0 | 36.1 |

The results in Table 2 show that the comparative samples had very low strength and density compared to samples 1-37 (the strength of bars made with samples 38-42 was not measured). This was due to the formation of gas bubbles when the comparative binding agents were mixed with the copper powder. The gas bubbles significantly decreased the strength and density of the comparative molded bars. Additionally, voids from the gas bubbles were visible in the surfaces of the comparative molded bars. The strength of the molded bars made using binding agent formulations 1-37 varied somewhat. Some of the best results were achieved using the additives acetic acid, ammonium dihydrogen phosphate, and phosphoric acid, or combinations thereof.

It was found that when acetic acid was used alone as an additive, the acetic acid removed oxidation from the copper powder. However, some reaction occurred during curing that produced a sufficient amount of gas to cause surface bulging in the molded bars made with acetic acid alone. When ammonium dihydrogen phosphate was combined with acetic acid, no surface bulging was observed. Therefore, in some cases the reaction inhibition additive can be a combination of acetic acid and ammonium dihydrogen phosphate.

### Example 3—Three-Dimensional Printing

A binding agent was prepared that included 40 wt % copper (II) nitrate trihydrate, 1.0 wt % acetic acid, 0.2 wt % ammonium dihydrogen phosphate, 0.5 wt % DOWFAX™ 2A1 surfactant from Dow Inc. (USA), and the balance water. The binding agent was loaded in a test metal three-dimensional printing system. The build material was the same copper powder used in Example 1. A sample object was printed using the three-dimensional printing system. The amount of binding agent that was applied to the build material was about 0.63 grams of binding agent per cubic centimeter of copper powder. The printed green body object was cured at 100° C. for 1 hour after printing. The green body strength was about 7-10 MPa after curing. Additional curing in a curing oven was performed at 150° C. for 2 hours. The green body strength increased to about 8-11 MPa after the additional curing. An X-ray diffraction test was performed, and a peak corresponding to the presence of copper hydroxynitrate was found. This indicates that copper hydroxynitrate was formed by the decomposition of the copper (II) nitrate trihydrate in the binding agent.

The three-dimensional printed bars were sintered in an atmosphere of argon and hydrogen at 1050° C. for 4 hours. The sintered bars had a density of about 90%. The bars were then treated by hot isostatic pressing at 950° C. for 2 hours in argon at a pressure of 14,750 psi. The density after hot isostatic pressing was from about 93% to about 96%.

While the present technology has been described with reference to certain examples, various modifications, changes, omissions, and substitutions can be made without departing from the disclosure.

What is claimed is:

1. A three-dimensional printing kit comprising:
a build material comprising particles of copper or a copper alloy; and
a binding agent comprising:
water,
copper (II) nitrate or a hydrate thereof, and
a reaction inhibition additive, wherein the additive is a copper oxide etchant, a water-soluble phosphate-containing compound, or a combination thereof.

2. The three-dimensional printing kit of claim 1, wherein the reaction inhibition additive comprises a copper oxide etchant selected from the group consisting of acetic acid, phosphoric acid, formic acid, propionic acid, phosphonoacetic acid, oxalic acid, sulfuric acid, nitric acid, and combinations thereof.

3. The three-dimensional printing kit of claim 1, wherein the reaction inhibition additive comprises a water-soluble phosphate-containing compound selected from the group consisting of ammonium dihydrogen phosphate, ammonium hydrogen phosphate, ammonium phosphate, phosphoric acid, sodium phosphate, sodium hydrogen phosphate, potassium phosphate, potassium hydrogen phosphate, potassium dihydrogen phosphate, lithium dihydrogen phosphate, lithium hydrogen phosphate, cesium phosphate, and combinations thereof.

4. The three-dimensional printing kit of claim 1, wherein the reaction inhibition additive is the copper oxide etchant, and wherein the three-dimensional printing kit further comprises a second fluid agent comprising water and a water-soluble phosphate-containing compound.

5. The three-dimensional printing kit of claim 1, wherein the reaction inhibition additive is present in an amount from about 0.01 wt % to about 5.0 wt % with respect to the total weight of the binding agent.

6. The three-dimensional printing kit of claim 1, wherein the binding agent comprises copper (II) nitrate trihydrate in an amount from about 20 wt % to about 70 wt % with respect to the total weight of the binding agent.

7. The three-dimensional printing kit of claim 1, wherein the binding agent further comprises a surfactant in an amount from about 0.025 wt % to about 2 wt % with respect to the total weight of the binding agent.

8. The three-dimensional printing kit of claim 1, wherein the binding agent is substantially free of organic humectant or comprises an organic humectant in an amount from about 0.1 wt % to about 10 wt %.

9. A three-dimensional printing system comprising:
a powder bed comprising a build material comprising particles of copper or a copper alloy;
a binding agent applicator fluidly coupled or coupleable to a binding agent, wherein the binding agent applicator is directable to iteratively apply the binding agent to layers of the build material, wherein the binding agent comprises water, copper (II) nitrate or a hydrate thereof, and a reaction inhibition additive, wherein the additive is a copper oxide etchant, a water-soluble phosphate-containing compound, or a combination thereof; and
a curing heater positioned to heat the powder bed to a curing temperature.

10. The system of claim 9, wherein the reaction inhibition additive is selected from the group consisting of acetic acid, phosphoric acid, formic acid, propionic acid, phosphonoacetic acid, oxalic acid, sulfuric acid, nitric acid, ammonium dihydrogen phosphate, ammonium hydrogen phosphate, ammonium phosphate, sodium phosphate, sodium hydrogen phosphate, potassium phosphate, potassium hydrogen phosphate, potassium dihydrogen phosphate, lithium dihydrogen phosphate, lithium hydrogen phosphate, cesium phosphate, and combinations thereof.

11. The system of claim 9, wherein the reaction inhibition additive is present in an amount from about 0.01 wt % to about 5.0 wt % with respect to the total weight of the binding agent, and wherein the binding agent comprises copper (II) nitrate trihydrate in an amount from about 20 wt % to about 70 wt % with respect to the total weight of the binding agent.

12. A method of making a three-dimensional printed object comprising:
selectively applying a binding agent onto a build material comprising particles of copper or a copper alloy, wherein the binding agent comprises:
water,
copper (II) nitrate or a hydrate thereof, and
a reaction inhibition additive, wherein the additive is a copper oxide etchant, a water-soluble phosphate-containing compound, or a combination thereof; and
heating the build material and selectively applied binding agent to bind a layer of the three-dimensional printed object.

13. The method of claim 12, wherein the reaction inhibition additive is selected from the group consisting of acetic acid, phosphoric acid, formic acid, propionic acid, phosphonoacetic acid, oxalic acid, sulfuric acid, nitric acid, ammonium dihydrogen phosphate, ammonium hydrogen phosphate, ammonium phosphate, sodium phosphate, sodium hydrogen phosphate, potassium phosphate, potassium hydrogen phosphate, potassium dihydrogen phosphate, lithium dihydrogen phosphate, lithium hydrogen phosphate, cesium phosphate, and combinations thereof, and wherein the reaction inhibition additive is present in an amount from about 0.01 wt % to about 5.0 wt % with respect to the total weight of the binding agent, and wherein the binding agent comprises copper (II) nitrate trihydrate in an amount from about 20 wt % to about 70 wt % with respect to the total weight of the binding agent.

14. The method of claim 12, further comprising sintering bound layers of the three-dimensional printed object to form a sintered three-dimensional printed object.

15. The method of claim 12, further comprising adding multiple additional layers of the build material and selectively applying the binding agent onto the multiple additional layers of the build material, wherein the heating the build material and selectively applied binding agent comprises heating the build material and the multiple additional layers of build material simultaneously to bind an entire three-dimensional printed object.
